(19) United States
(12) Patent Application Publication
(10) Pub. No.: US 2007/0151412 A1
(43) Pub. Date: Jul. 5, 2007

(54) HAND-GUIDED POWER TOOL, IN PARTICULAR ROTARY HAMMER AND/OR CHISEL HAMMER

(76) Inventors: Gerhard Meixner, Filderstadt (DE); Helmut Heinzelmann, Stuttgart (DE); Michael Weiss, Stuttgart (DE)

Correspondence Address: MICHAEL J. STRIKER, 103 EAST NECK ROAD, HUNTINGTON, NY, 11743, US

(21) Appl. No.: 11/616,349

(22) Filed: Dec. 27, 2006

(30) Foreign Application Priority Data
Dec. 29, 2005 (DE) 20 2005 020 647.4

(51) Int. Cl. F16H 48/12

(52) U.S. Cl. 74/650

(57) ABSTRACT

A hand-guided power tool has an impact mechanism and a gear transmission provided to transmit a drive torque to the impact mechanism and including at least one gear with a bevel gearing and at least one additional gear with another gearing supported so that they are rotatable around a common rotation axis.

### CROSS-REFERENCE TO A RELATED APPLICATION

The invention described and claimed hereinbelow is also described in DE 20 2005 020647.4, filed Dec. 29, 2005. This German Patent Application, whose subject matter is incorporated here by reference, provides the basis for a claim of priority of invention under 35 U.S.C. 119 (a)-(d).

### BACKGROUND OF THE INVENTION

The invention is based on a hand-guided power tool.

There are known hand-guided power tools, in particular rotary hammers and/or chisel hammers, which are equipped with an impact mechanism and a gear transmission that is provided to transmit a drive torque to the impact mechanism.

### SUMMARY OF THE INVENTION

The invention is based on a hand-guided power tool, in particular a rotary hammer and/or chisel hammer, which is equipped with an impact mechanism and a gear transmission that is provided for transmitting a drive torque to the impact mechanism.

According to the invention, the gear transmission has at least one gear with a bevel gearing and at least one additional gear with another gearing, which gears are supported so that they are able to rotate around a common rotation axis, thus making it possible to implement a particularly space-saving construction. The term “bevel gearing” should in particular be understood to mean a gearing that is formed onto a beveled end surface of the gear. In addition, the term “impact mechanism” should in particular be understood to be a unit that is provided to convert a rotary motion into a translatory hammering motion.

In another embodiment of the present invention, the additional gear has a spur gearing; the term “spur gearing” should be understood in this context to be a gearing on an end surface of the gear extending essentially parallel to the rotation axis. The expression “essentially parallel” should in particular be understood to mean that the end surface has an angular deviation in relation to the rotation axis of less than 10° and preferably less than 5°. Through a corresponding embodiment, it is advantageously possible for the drive torque to be transmitted at an angle in a space-saving manner, which allows the corresponding embodiment to be used in a particularly advantageous fashion in hand-guided power tools in which a motor shaft encloses an angle not equal to zero with an impact mechanism axis.

If the bevel gearing and the spur gearing at least essentially enclose an angle of 45°, then in a structurally simple-to-manufacture hand-guided power tool in a so-called L-construction in which a motor shaft encloses an angle of 90° with an impact mechanism axis, it is possible to transmit the drive torque between the motor shaft and the impact mechanism in an advantageous fashion. The expression “essentially” should in particular be understood to mean that the bevel gearing and the spur gearing enclose an angle that deviates from a 45° angle by an angular deviation of less than 10° and preferably less than 5°.

A compact construction can also be promoted if a motor pinion supported on a motor shaft is coupled to the spur gearing and particularly if the spur gearing is situated on a side of the bevel gearing oriented away from the motor, particularly viewed in the direction of the rotation axis.

The impact mechanism can have various drive units for converting a rotary motion into a hammering motion such as a cam unit or advantageously, a wobble bearing unit, which can in turn be integrated into the device in a particularly space-saving fashion. The term “wobble bearing unit” should in particular be understood to mean a unit in which, due to a wobble mechanism situated obliquely on a bearing mechanism, a wobbling motion of the wobble mechanism occurs when the bearing mechanism rotates.

According to another embodiment of the invention, the gears are spaced apart from each other by a smaller distance in the axial direction than a span of the bevel gearing in the axial direction, which makes it possible to achieve a unit comprising the gears that is particularly compact in the axial direction of the rotation axis, particularly if the gears adjoin each other directly in the axial direction.

If the gears are supported by a shared bearing position and/or the gears are integrally joined to each other, this makes it possible to eliminate additional components, save space, and reduce assembly complexity and costs.

It is also possible to eliminate components and save space if the gears are supported on one side. The expression “one-sided support” should in particular be understood to mean that the gears are supported on only one side, viewed in the axial direction of their rotation axes.

Other advantages ensue from the following description of the drawing. The drawing, the description, and the claims contain numerous features in combination. Those skilled in the art will also suitably consider the features individually and unite them into other meaningful combinations.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single figure of the drawings is a view schematically showing a hand-guided power tool, in particular a rotary hammer and/or chisel hammer, in accordance with the present invention.

### DESCRIPTION OF THE PREFERRED EMBODIMENTS

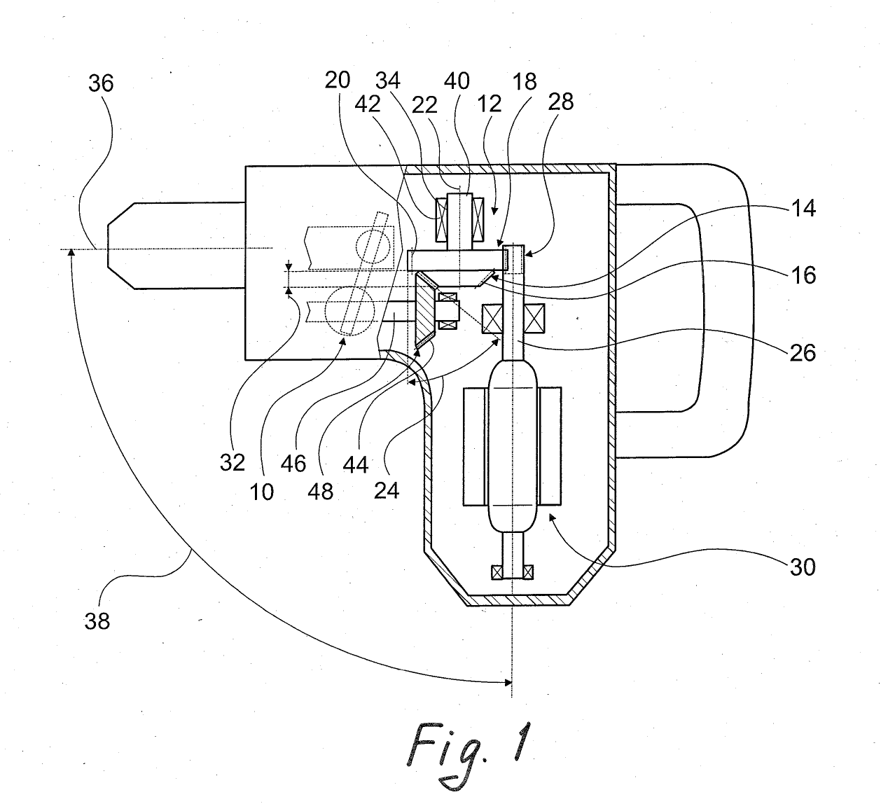

FIG. 1 schematically depicts a hand-guided power tool embodied in the form of a chisel hammer, having an impact mechanism 10 equipped with a wobble bearing unit and having a gear mechanism 12 that is provided to transmit a drive torque from a motor shaft 26 of an electric motor 30 to the impact mechanism 10. The hand-guided power tool has a so-called L-construction in which the motor shaft 26 or its rotation axis encloses an angle 38 of 90° with an impact mechanism axis 36 of the hand-guided power tool.

The gear transmission 12 has a gear 14 with a bevel gearing 16 and an additional gear 18 with a spur gearing 20 that are integrally joined to each other and are supported together on a common axle 40 so that they are able to rotate around a common rotation axis 22. The spur gearing 20 is formed onto an end surface of the gear 18 oriented parallel to the rotation axis 22. The gears 14, 18 are spaced apart from each other in the direction of the rotation axis 22 by a smaller distance than a span 32 of the bevel gearing 16 in the axial direction of the rotation axis 22 and in fact, the gears 14, 18 adjoin each other directly in the axial direction of the rotation axis 22.

By means of the axle 40 and a common bearing position 34, the gears 14, 18 are supported on one side in a common bearing 42, on a side oriented away from the electric motor 30. The bearing 42 is situated essentially, i.e. in particular by more than 50%, on the side of the impact mechanism axis 36 oriented away from the electric motor 30 in the direction of the rotation axis 22.

The bevel gearing 16 and the spur gearing 20 enclose an angle 24 of 45°. Fundamentally, however, other angles deemed useful to those skilled in the art are also conceivable, which makes it easily possible to achieve various angles between the motor shaft 26 and the impact mechanism axis 36.

The spur gearing 20, viewed in the direction of the rotation axis 22, is situated on a side of the bevel gearing 16 oriented away from the electric motor 30 and meshes with a motor pinion 28 formed onto the motor shaft 26. The bevel gearing 16 meshes with a bevel gearing 44 of a gear 48 situated on a shaft 46 extending parallel to the impact mechanism axis 36.

The wobble bearing unit of the impact mechanism 10 is supported on the shaft 46. During operation, the wobble bearing unit is driven via the shaft 46.

It will be understood that each of the elements described above, or two or more together, may also find a useful application in other types of constructions differing from the types described above.

While the invention has been illustrated and described as embodied in a hand-guided power tool, in particular a rotary hammer and/or chisel hammer, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hand-guided power tool, comprising an impact mechanism; a gear transmission provided to transmit a drive torque to said impact mechanism, said gear transmission including at least one gear with a bevel gearing and at least one additional gear with another gearing supported so that they are rotatable around a common rotation axis.

2. A hand-guided power tool as defined in claim 1, wherein said additional gear is configured as a spur gearing.

3. A hand-guided power tool as defined in claim 2, wherein said bevel gearing and said spur gearing enclose at least substantially an angle of 45°.

4. A hand-guided power tool as defined in claim 2; and further comprising a motor pinion which is supported on a motor shaft and coupled to said spur gearing.

5. A hand-guided power tool as defined in claim 4, wherein said spur gearing is situated on a side of said bevel gearing oriented away from a motor.

6. A hand-guided power tool as defined in claim 1, wherin said impact mechanism is provided with a wobble gearing.

7. A hand-guided power tool as defined in claim 1, wherein said gears are spaced apart from each other in an axial direction by a distance less than a span of said bevel gearing in the axial direction.

8. A hand-guided power tool as defined in claim 7, wherein said gears adjoin each other directly in the axial direction.

9. A hand-guided power tool as defined in claim 1, wherein said gears are supported by a common bearing position.

10. A hand-guided power tool as defined in claim 1, wherein said gears are configured so that they are integrally joined to each other.

11. A hand-guided power tool as defined in claim 1, wherein said gears are configured so that they are supported on one side.
